(19) United States
(12) Patent Application Publication
(10) Pub. No.: US 2012/0194858 A1
(43) Pub. Date: Aug. 2, 2012

(54) IMAGE FORMING SYSTEM AND IMAGE FORMING APPARATUS

(75) Inventor: Kouichirou MATSUSHITA, Kokubunji-shi (JP)

(73) Assignee: KONICA MINOLTA BUSINESS TECHNOLOGIES, INC., Chiyoda-ku (JP)

(21) Appl. No.: 13/349,843

(22) Filed: Jan. 13, 2012

(30) Foreign Application Priority Data
Jan. 27, 2011 (JP) 2011-015647

(51) Int. Cl. G06K 15/02

(52) U.S. Cl. 358/1.15

(57) ABSTRACT

The image forming system of the present invention includes a print job transmitting apparatus and an image forming apparatus, wherein the print job transmitting apparatus includes: a number setting unit for setting the number of recording media; and a transmission unit for transmitting a print job that contains number information indicating the number of recording media; while the image forming apparatus includes: an image forming unit for forming images on recording media; a storing unit for storing recording media on which images are formed; a judging unit for judging as to whether or not the number of recording media matches with the number indicated by the number information; and a control unit for discharging recording media to a first discharge destination when it is judged that the numbers match and discharging recording media to a second discharge destination when it is judged that the numbers do not match.

### CROSS-REFERENCE TO RELATED APPLICATION

This application is based on Japanese Patent Application No. 2011-015647 filed on Jan. 27, 2011, the contents of which are incorporated herein by reference.

### BACKGROUND

1. Technical Field

The present invention relates to an image forming system and an image forming apparatus. The present invention particularly relates to an image forming system and an image forming apparatus used for carbon copy printing.

2. Description of Related Art

So-called “carbon copy printing” is often used these days in public institutions such as municipal offices and hospitals for producing a set of business forms consisting of “Client-use” form, “Process-use” form, “Filing-use” form, and the like by an image forming apparatus such as MFP (Multi-Function Peripheral). In the carbon copy printing, images that correspond to various business forms are formed on a plurality of sheets of paper respectively by executing a print job generated on a PC (Personal Computer) by the MFP, and a plurality of sheets of paper on which images are formed are output from the MFP (e.g., refer to Unexamined Japanese Patent Publication No. 2007-213365). It is important in the carbon copy printing to have all the business forms that constitute a complete set are prepared properly.

However, all the business forms that constitute a complete set are not produced properly sometimes due to malfunctions such as a paper jam in the MFP during the execution of a print job. For example, if a paper jam occurs during the execution of a print job and the print job is forced to be terminated, the printing process may terminate without printing a certain form of a set of business forms. Or, if the print job is not forced to be terminated and the printing process continues despite the paper jam, it may end up printing a certain form redundantly.

For example, if the printing process of a set of business forms consisting of abovementioned three forms terminates without printing the “Process-use” form, and the user picks up only the two forms from the MFP without noticing the “Process-use” form is missing, the process will not be done even though the client receives the “Client-use” form. On the other hand, if the “Process-use” form is printed redundantly, and the user picks up the wrong set from the MFP without noticing there are two “Process-use” forms, the process may be done twice for the same business form.

Therefore, if a set of business forms is not prepared properly, it is desirable to have the user notice the set of business forms is not produced properly to prevent the user from picking up the wrong set from the MFP without noticing the error.

Incidentally, Unexamined Japanese Patent Publication No. 2007-253343 discloses an image forming apparatus that stores printed sheets of paper in its storing unit located inside the apparatus until the printing process for all the sheets of paper is completed, and outputs all the sheets of paper in one stroke after the printing process is over, in case when images are printed on a plurality of sheets of paper. Such a configuration can prevent the user from picking up a portion of the business forms before the printing process is over and ending up making business forms break apart. However, in the abovementioned image forming apparatus, even an improper set of forms may be output just like a proper set of forms, so that the user may not notice that the business forms are not prepared properly.

### SUMMARY

The present invention is made to solve the problems described above. An object of the present invention is to provide an image forming system and an image forming apparatus that are capable of causing the user to notice that a set of recording media is not prepared properly and preventing the user from picking up the recording media from the image forming apparatus without noticing the set of recording media is not prepared properly, if the set of recording media on which images are formed is not prepared properly.

To achieve at least one of the abovementioned objects, an image forming system reflecting one aspect of the present invention includes a print job transmitting apparatus which transmits a print job and an image forming apparatus which forms images by executing the print job, wherein the print job transmitting apparatus includes: a number setting unit for setting the number of recording media on which images are formed by the image forming apparatus; and a transmission unit for transmitting a print job that contains number information indicating the number of recording media set up by the number setting unit to the image forming apparatus; while the image forming apparatus includes: an image forming unit for forming images on recording media based on the print job; a storing unit for storing the recording media on which images are formed by the image forming unit; a judging unit for judging as to whether or not the number of recording media stored in the storing unit matches with the number indicated by the number information when termination of image forming process by the image forming unit is recognized; and a control unit for executing an output control for discharging the recording media stored in the storing unit to a first discharge destination when it is judged that the numbers match by the judging unit, and discharging the recording media to a second discharge destination which is different from the first discharge destination when it is judged that the numbers do not match by the judging unit.

It is preferable in the abovementioned image forming system that the print job transmitting apparatus further includes: a control setting unit for setting as to whether or not to execute the output control by the control unit for a print job, wherein the output control is executed by the control unit in case when it is set to execute the output control for the print job; and the recording media stored in the storing unit are discharged to the first discharge destination in case when the output control is not executed by the control unit.

It is preferable in the abovementioned image forming system that the print job contains data for forming images of a plurality of pages containing objects common to those pages on recording media for each page.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall configuration of an image forming system according to an embodiment of the present invention.

FIG. 2 is a block diagram showing the configuration of the PC shown in FIG. 1.

FIG. 3 is a schematic front view showing the configuration of the MFP shown in FIG. 1.

FIG. 4 is a block diagram showing the configuration of the MFP shown in FIG. 1.

FIG. 5 is a drawing showing an example of one set of business forms produced by a carbon copy printing.

FIG. 6 is a flowchart showing a procedure of the printing instruction process executed on the PC.

FIG. 7 is a drawing showing an example of an output setting screen displayed on the display of the PC.

FIG. 8 is a flowchart showing a procedure of the printing process executed on the MFP.

FIG. 9 is a drawing showing an example of the print data transmitted from the PC to the MFP.

FIG. 10 is a block diagram showing the contents of the HDD of an MFP according to a variant example.

### DETAILED DESCRIPTION

The embodiments of the present invention will be described below with reference to the accompanying drawings.

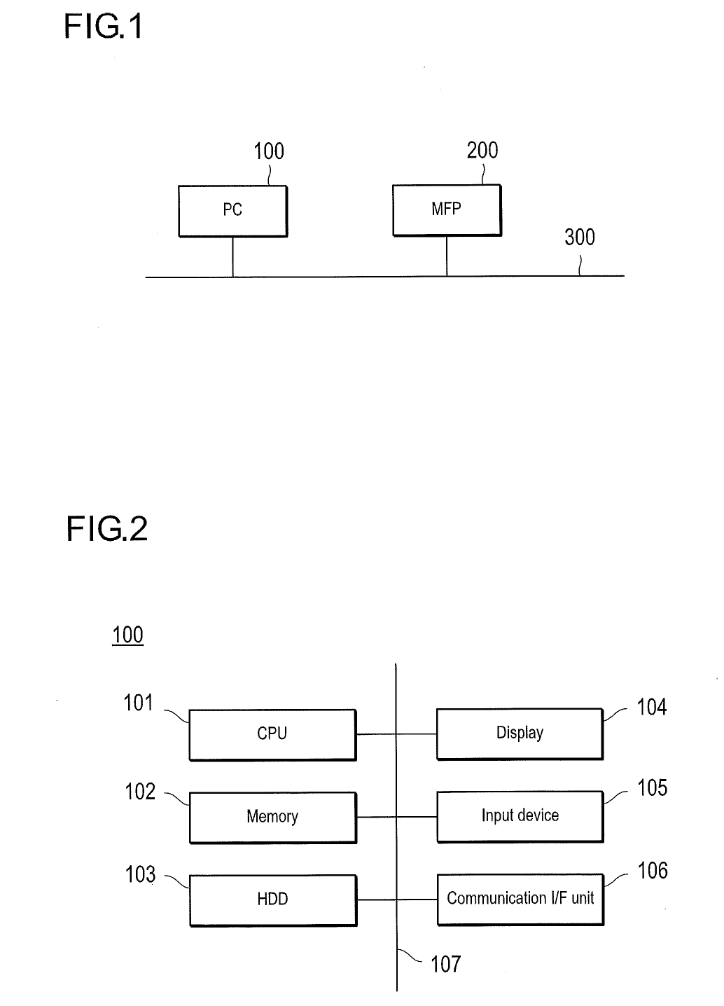

FIG. 1 is a block diagram showing the overall configuration of an image forming system according to an embodiment of the present invention.

The image forming system of the present embodiment is equipped with a PC 100 as the print job transmitting apparatus and an MFP 200 as an image forming apparatus, which are connected via a network 300 so that they can communicate with each other.

The network 300 consists of a LAN (Local Area Network) that connects computers and network equipment with each other based on standards such as Ethernet, TokenRing, and FDDI (Fiber Distributed Data Interface), a WAN (Wide Area Network) that connects LANs via dedicated lines, etc. The types and quantities of equipment to be connected to the network 300 are not limited to the example shown in FIG. 1. The PC 100 and the MFP 200 can be connected directly (locally connected) without relying on the network 300.

FIG. 2 is a block diagram showing the configuration of the PC shown in FIG. 1. The PC 100 is equipped with a CPU (Central Processing Unit) 101, a memory 102, a HDD (Hard Disk Drive) 103, a display 104, an input device 105, and a communication I/F (interface) unit 106, all of which are connected with each other via a bus 107 for exchanging signals.

The CPU 101 controls various units described above and executes various arithmetic processes according to a program. The memory 102 is equipped with a ROM (Read Only Memory) which stores various programs and data preliminarily, a RAM (Random Access Memory) which stores programs and data temporarily as a working area, etc.

The HDD 103 stores various programs including the operating system and various data. The HDD 103 is installed with a document file preparation application for preparing document file and a printer driver for converting document files into print data described in a page description language (PDL) that the MFP 200 can understand. The document file preparation application includes, for example, the dedicated application for preparing the business form.

The display 104 is typically a liquid crystal display capable of displaying various kind of information. The input device 105 includes a pointing device such as a mouse or a keyboard, and is used for executing various inputs.

The communication I/F unit 106 is an interface for communicating with other kinds of equipment via the network 300, in which standards such as Ethernet, Token Ring, and FDDI are used.

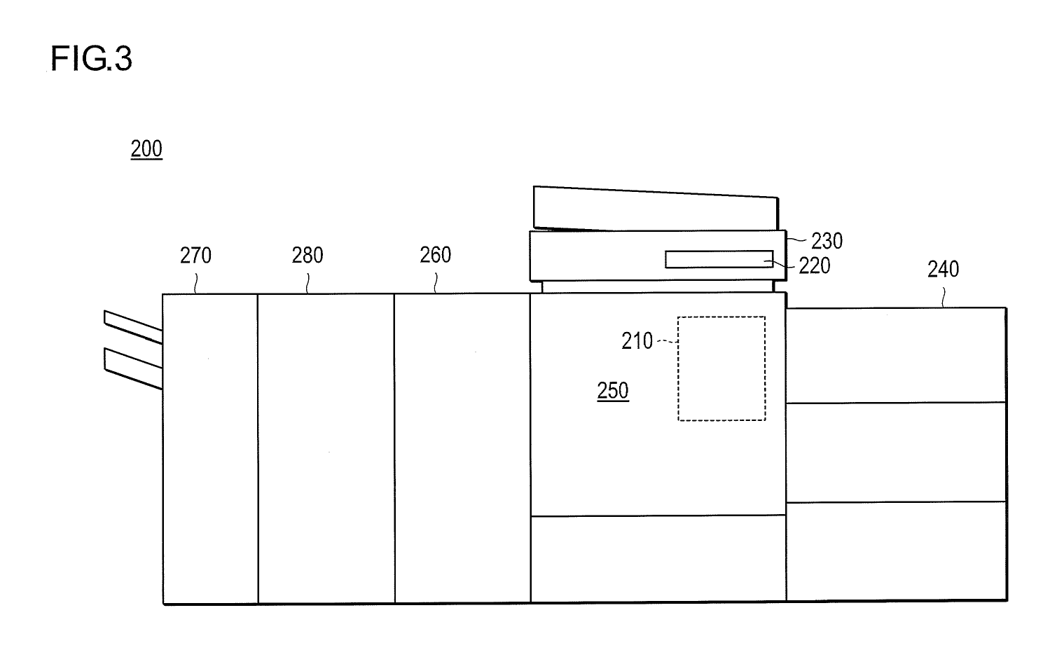

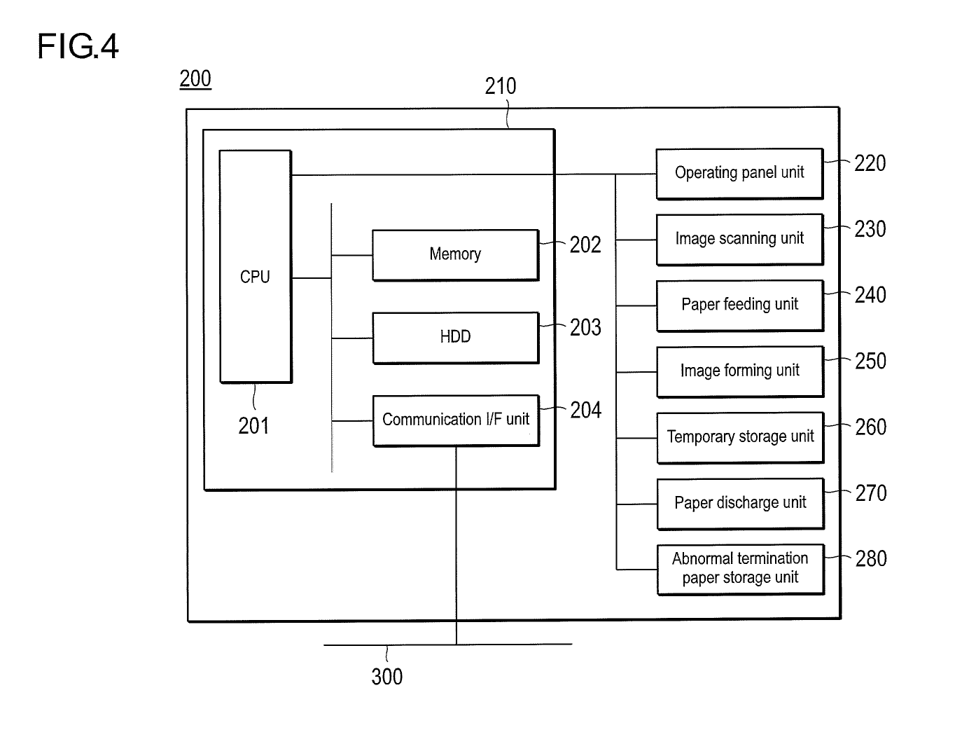

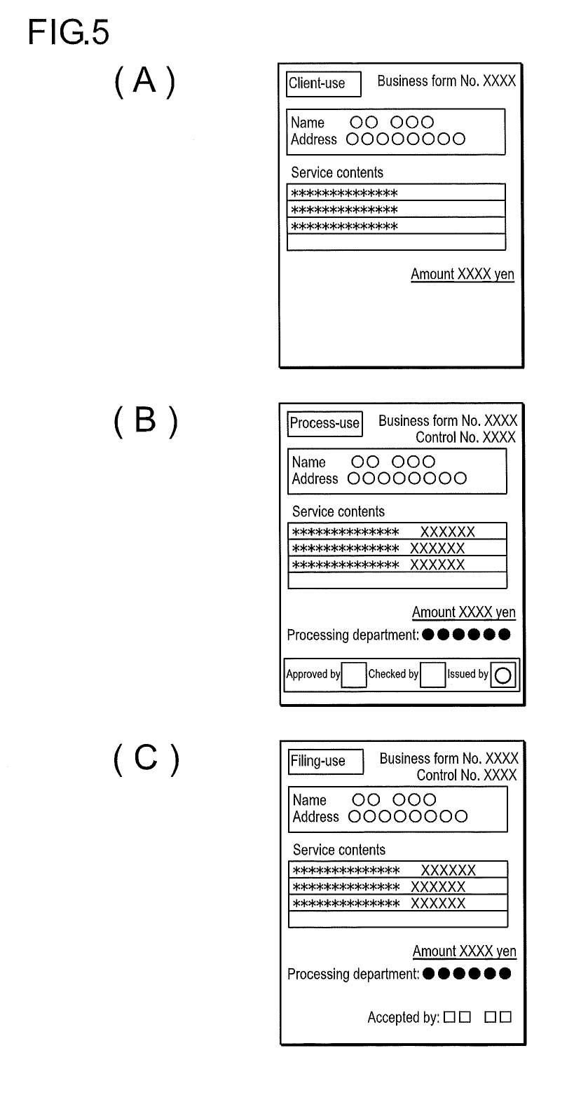

FIG. 3 is a schematic front view showing the configuration of the MFP shown in FIG. 1, while FIG. 4 is a block diagram showing the configuration of the MFP shown in FIG. 1.

The MFP 200 is equipped with a control unit 210, an operating panel unit 220, an image scanning unit 230, a paper feeding unit 240, an image forming unit 250, a temporary storage unit 260, a paper discharge unit 270, and an abnormal termination paper storage unit 280, all of which are connected with each other via a bus in order to exchange signals. In order to avoid redundancy, the description of those units among the abovementioned units of the MFP 200 having the identical functions as those of the PC 100 is omitted here.

The control unit 210 has a CPU 201, a memory 202, a HDD 203, and a communication I/F unit 204. The HDD 203 stores an image data generating program for generating image data of the bitmap format by converting print data received from the PC 100 and an abnormal termination process execution program for executing an abnormal termination process to store sheets of paper in the abnormal termination paper storage unit 280 when an abnormal termination of the printing process is recognized.

The operating panel unit 220 is equipped with a touchscreen, a numeric key pad, start button, stop button, etc., and is used for displaying various kinds of information and entering various instructions.

The image scanning unit 230 irradiates the document which is manually set at the designated scanning position, or automatically transferred to the designated scanning position by the ADF (Auto Document Feeder), with a light source such as a fluorescent lamp, and converts the light reflected from the document by an imaging apparatus such as a CCD (Charge Coupled Device) image sensor in order to generate image data from its electrical signal.

The paper feeding unit 240 stores sheets of paper to be used as a recording medium in printing. The paper feeding unit 240 is equipped with a plurality of paper feeding trays and feeds the sheets of paper stored in a paper feeding tray one sheet at a time to the image forming unit 250.

The image forming unit 250 forms images on the sheet of paper based on various data using a publicly known imaging process such as an electronic photography process consisting of various steps such as charging, exposing, developing, transferring, and fixing steps.

The temporary storage unit 260 functions as a storing unit to temporarily store the printed sheets of paper transferred from the image forming unit 250. The temporary storage unit 260 has a transfer mechanism (not shown) for transferring sheets of paper and discharges all sheets of paper together to the paper discharge unit 270 or the abnormal termination paper storage unit 280 when the termination of a printing process is recognized. The temporary storage unit 260 is provided with a sensor and a counter (not shown) for identifying the number of printed sheets of paper transferred from the image forming unit 250.

The paper discharge unit 270 discharges the printed sheets of paper stored in the temporary storage unit 260. The paper discharge unit 270 has a plurality of paper discharge trays, and the printed sheets of paper transferred from the temporary storage unit 260 are discharged to the specified paper discharge tray. The paper discharge unit 270 is equipped with a post-processing apparatus (not shown) for performing post-processes such as stapling and punching processes, and can perform post-process to the printed sheets of paper according to the printing setting. Incidentally, the paper discharge unit 270 can be equipped with a paper discharge box which has a door for taking out the sheets of paper, and the printed sheets of paper transferred from the temporary storage unit 260 can be stored in the paper discharge box.

The abnormal termination paper storage unit 280 keeps the printed sheets of paper stored in the temporary storage unit 260. The abnormal termination paper storage unit 280 of the present embodiment has a door (not shown) for taking out the sheets of paper, and prevents the sheets of paper transferred from the temporary storage unit 260 from being discharged inadvertently to the outside of the MFP 200.

The PC 100 and the MFP 200 may each include components other than those components mentioned above or may lack a portion of those components mentioned above.

Next, the carbon copy printing will be described with reference to FIG. 5.

FIG. 5 is a drawing showing an example of one set of business forms produced by a carbon copy printing. In the carbon copy printing, a set of business forms is produced by forming the image that corresponds to each form on a sheet of paper by the MFP 200. For example, it produces a set of three business forms consisting of “Client-use” form, a “Process-use” form, and a “Filing-use” form as shown in FIG. 5 (A) through FIG. 5 (C).

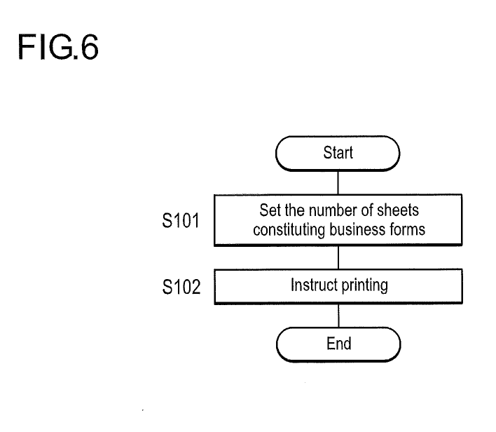

Such images of a set of business forms are edited on the PC 100 using, for example, the dedicated application. By transmitting the print data of the edited images of the business forms from the PC 100 to the MFP 200, a set of business forms is produced by the MFP 200. The operation of the image forming system according to the present embodiment is described below with reference to FIG. 6 through FIG. 9.

FIG. 6 is a flowchart showing a procedure of the printing instruction process executed on the PC. In the present embodiment, after the business forms are edited by means of the application for preparing the business form, the printer driver is activated via the application. The printing instruction is performed by the user of the PC 100 via the printer driver. The algorithm shown in the flowchart of FIG. 6 is stored as a program in the HDD 103 of the PC 100 and is executed by the CPU 101.

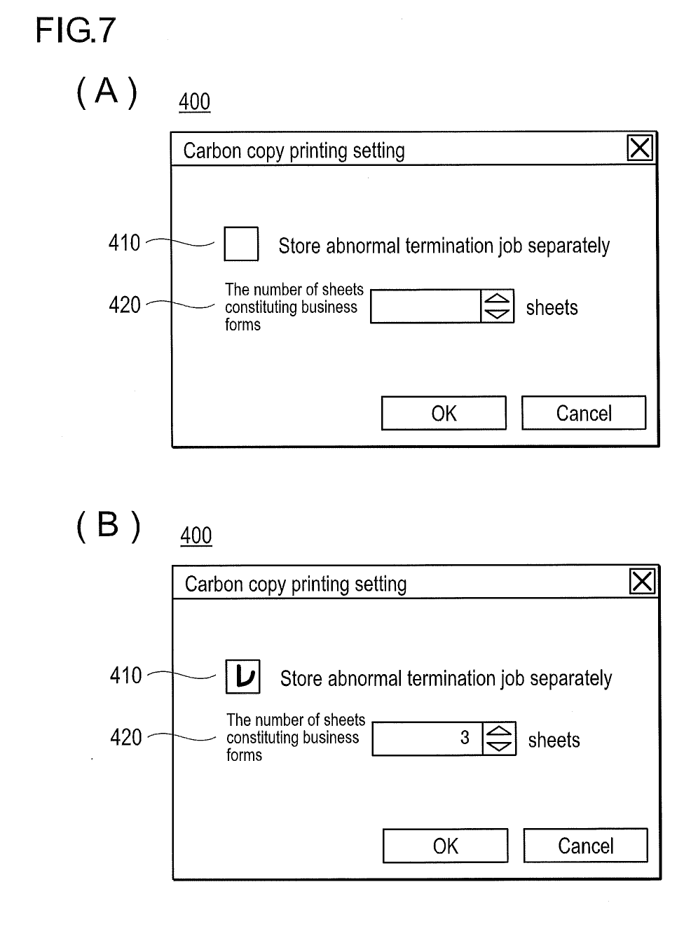

The number of sheets constituting business forms is set first in the printing instruction process (step S101). In the present embodiment, an output setting screen 400 (see FIG. 7 (A)) for setting the number of sheets constituting business forms is displayed on the display 104 of the PC 100 as the printer driver is activated. The number of the sheets that constitute one set of business forms is set by the user of the PC 100 via the output setting screen 400 displayed on the display 104.

FIG. 7 is a drawing showing an example of an output setting screen. As shown in FIG. 7 (A), the output setting screen 400 has a check box 410 for setting the execution of the abnormal termination process for the print job, and a spin button 420 for setting the number of sheets that constitute one set of business forms. In the process shown in step S101, the number of sheets constituting business forms is set as the user checks the check box 410 and specifies the number of sheets by the spin button 420 (see FIG. 7 (B)).

Next, the printing process is instructed to the MFP 200 (step S102). In the present embodiment, the print data of the business forms containing the number information that indicates the number of sheets set in the process shown in step S101 is generated, and the print data is transmitted from the PC 100 to the MFP 200.

As can be seen from the above, according to the process of the flowchart shown in FIG. 6, the number of sheets that constitute one set of business forms is set, and the print data containing the number information indicating the number of sheets is transmitted to the MFP 200.

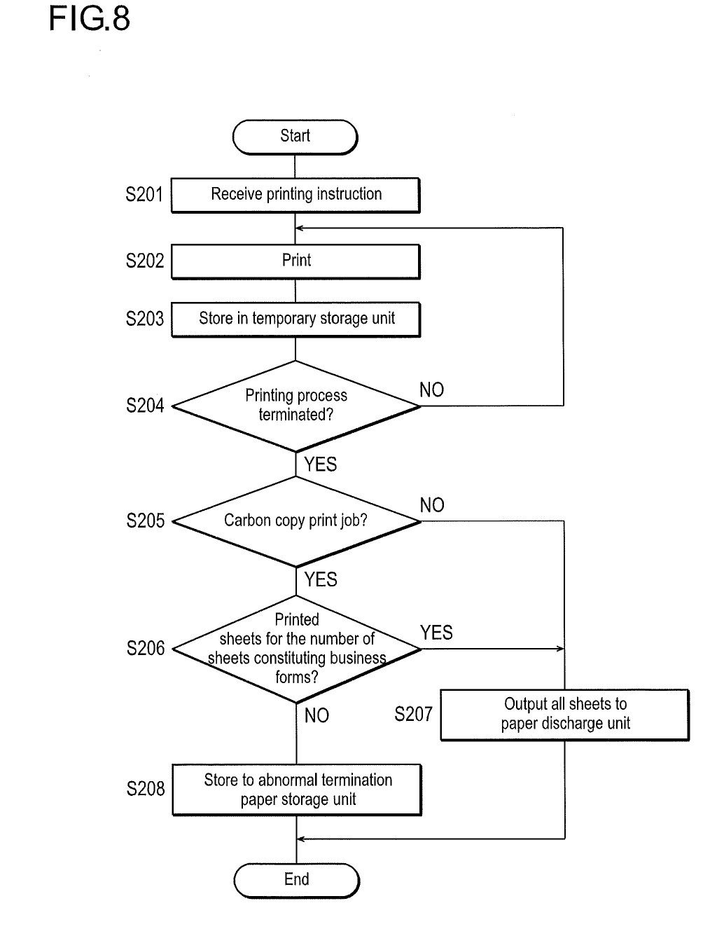

FIG. 8 is a flowchart showing a procedure of the printing process executed on the MFP. The algorithm shown in the flowchart of FIG. 8 is stored as a program in the HDD 203 of the MFP 200 and is executed by the CPU 201.

The printing instruction is received first in the printing process (step S201). In the present embodiment, the print data transmitted from the PC 100 is received as a print job.

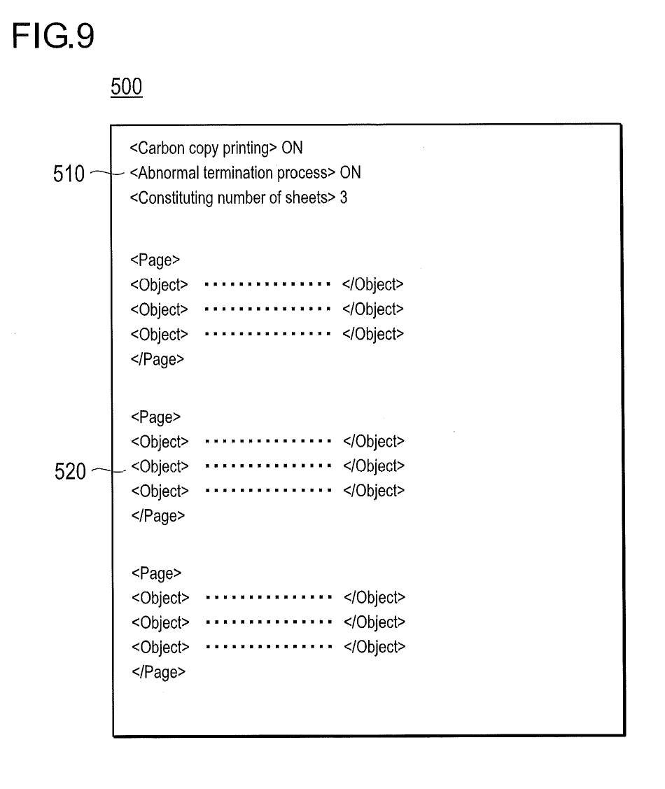

FIG. 9 is a drawing showing an example of the print data transmitted from the PC to the MFP. The print data 500 is data for forming images of a plurality of pages on sheets of paper page by page, and has a header part 510 and a body part 520. The header part 510 contains descriptions of the information indicating the execution of the carbon copy printing, the information indicating the execution of the abnormal termination process, and the number information indicating the number of sheets that constitute a set of business forms. The body part 520 contains descriptions of the information indicating the objects included in the images of the business forms (pages). In the carbon copy printing, there are many objects that are common to all the pages.

Next, the image printing is executed (step S202). In the present embodiment, the image of one business form is formed on a sheet of paper based on the print data.

Next, the sheet is stored in the temporary storage unit 260 (step S203). In the present embodiment, the sheet of paper on which the image of the business form is formed in the process shown in step 5202 is stored in the temporary storage unit 260.

Next, a judgment is made as to whether or not the printing process is terminated (step S204). In the present embodiment, a judgment is made as to whether or not the image forming process for forming images of business forms on sheets of paper is terminated. The termination of the printing process here does not only means a case when the print job is completed to the very end, but also includes a case when the print job is forced to be terminated due to a cancellation instruction of the print job or paper jam during the execution of the print job.

If it is judged that the printing process is not terminated (step S204: No), it returns to the process of step S202. As a result, the image of the next page (business form) is formed on a sheet of paper.

On the other hand, if it is judged that the printing process is terminated (step S204: Yes), a judgment is made as to whether or not the print job is a carbon copy print job (step S205). In the present embodiment, the header part 510 of the print data 500 is referenced in order to make a judgment as to whether or not the information indicating the execution of the carbon copy printing and the information indicating the execution of the abnormal termination process are “ON”. If these types of information are “ON”, it is judged that the print job is a carbon copy print job.

If it is judged that the print job is not a carbon copy print job (step S205: No), all the sheets of paper are discharged to the paper discharge unit 270 (step S207), and the process is terminated. In the present embodiment, the sheets of paper that are stored in the temporary storage unit 260 are discharged to the paper discharge unit 270, which is the normal discharge destination, on the premise that no abnormal termination process is to be executed.

On the other hand, if it is judged that the print job is a carbon copy print job (step S205: Yes), a judgment is made as to whether or not the printing for the number of sheets constituting business forms is executed (step S206). In the present embodiment, a judgment is made as to whether or not the number of sheets stored in the temporary storage unit 260 matches with the number of sheets indicated by the number information of the print data. In case it is judged that the number of sheets matches, it is determined that the printing for the number of sheets constituting business forms is executed.

If it is judged that the printing for the number of sheets constituting business forms is executed (step S206: Yes), all the sheets of paper are discharged to the paper discharge unit 270 (step S207), and the process is terminated. In the present embodiment, a set of business forms stored in the temporary storage unit 260 is discharged to the paper discharge unit 270 which is the normal discharge destination, because the number of sheets on which images are formed (i.e., business forms) matches with the preset number of sheets. As a set of business forms is discharged to the paper discharge unit 270, a plurality of business forms that constitute one set of business forms are discharged to the same or different paper discharge tray (or paper discharge box) depending on the printing setting.

On the other hand, if it is judged that the printing for the number of sheets constituting business forms is not executed (step S206: No) in the process shown in step S206, all the sheets of paper are stored in the abnormal termination paper storage unit 280 (step S208), and the process is terminated. In the present embodiment, a set of business forms with a deficient or excess number of sheets stored in the temporary storage unit 260 is discharged to the abnormal termination paper storage unit 280, because the number of sheets on which images are formed (i.e., business forms) does not match with the preset number of sheets. For example, if the printing process is forcibly terminated by a cancellation instruction of the print job being executed, the number of sheets of the business forms is deficient. Alternatively, if a printing process is resumed without being terminated forcibly after an occurrence of a paper jam during the execution of a print job and same images are formed redundantly, the number of sheets becomes excess. In the process shown in step S208, a set of business forms with a deficient or excess number of sheets is stored in the abnormal termination paper storage unit 280. The user can realize that the business forms are not prepared properly by noticing a set of business forms with a deficient or excess number of sheets being stored in the abnormal termination paper storage unit 280.

As can be seen from the above, according to the process of the flowchart shown in FIG. 8, the sheets of paper on which the images are formed by the image forming unit 250 are stored in the temporary storage unit 260, and a judgment is made as to whether or not the print job is a carbon copy print job when the termination of the printing process is recognized. When it is judged that the print job is a carbon copy print job, a judgment is made as to whether or not the number of sheets of paper stored in the temporary storage unit 260 matches with the preset number of sheets of paper. Moreover, if it is judged that the number of sheets of paper matches with the preset value, the set of sheets of paper (i.e., a set of business forms) stored in the temporary storage unit 260 is transferred to the paper discharge unit 270 and then discharged from the paper discharge tray. On the other hand, if it is judged that the number of sheets of paper does not match with the preset value, the business forms stored in the temporary storage unit 260 are sent to the abnormal termination paper storage unit 280 for storage.

With such a configuration, the user can realize that the set of business forms is not prepared properly, when the set of business forms was not produced in just proportion due to the abnormal termination of the printing process. Therefore, it prevents the business forms from being picked up from the MFP 200 by the user without noticing that the business forms are not prepared properly. Consequently, it prevents problems that may arise from the business forms being picked up from the MFP 200 accidentally by the user without noticing that the business forms are not prepared properly.

Moreover, when the user reprints a set of business forms realizing that it was not prepared properly, the set of business forms whose printing process was completed properly and the set of business forms whose printing process was abnormally terminated are discharged to different destinations so that the two sets do not get mixed up. Therefore, it prevents the same business forms from being processed redundantly due to the mixing of the two sets of business forms.

(Variant Example)

In the embodiment described above, the print job is generated by the PC 100 which functions as the print job transmitting apparatus and transmitted to the MFP 200. However, the print job can be generated by the MFP 200.

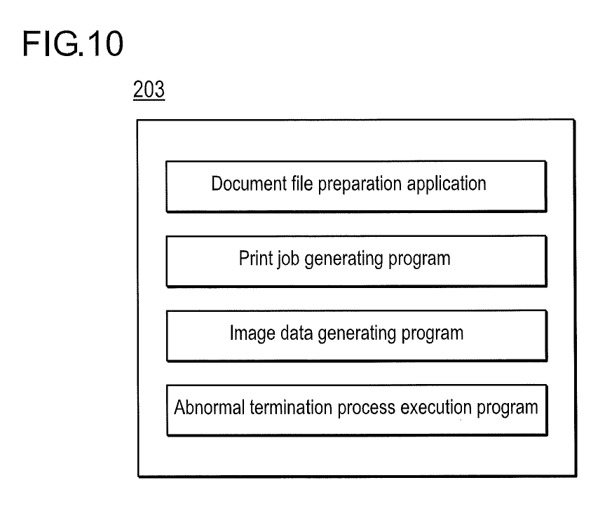

FIG. 10 is a diagram showing the contents of the HDD of an MFP according to a variant example. The HDD 203 stores a document file preparation application (application for preparing the business form) for preparing document files, a print job generating program for converting a document file into print data described in a PDL that the MFP 200 can understand, an image data generating program for generating image data of the bitmap format by converting print data, and an abnormal termination process execution program for executing an abnormal termination process to store sheets of paper in the abnormal termination paper storage unit 280 when an abnormal termination of the printing process is recognized.

Other than the fact that the document file preparation application and the print job generating program (printer driver) are stored in the HDD 203, the configuration of the MFP according to the variant example is identical to the configuration of the MFP of the present embodiment, so that the detail description is omitted here.

With such a configuration, the print job is generated inside the MFP 200 and the print job is executed, when the user sets the number of sheets constituting business forms and instructs the execution of printing after editing the business forms by means of the application for preparing the business form via the operating panel unit 220 of the MFP 200. If a set of business forms is not produced in just proportion due to abnormal termination of the printing process, the resulting business forms are stored in the abnormal termination paper storage unit 280.

The present invention is not limited to the embodiment described above, but also can be changed in various ways within the scope of the claims.

For example, in the above embodiment, the number of sheets that constitute a set of business forms is set by the user's operation. However, the number of sheets can be preset in accordance with the application which activates the printer driver (or a template of business form included in the application) and automatically set when the printer driver is activated.

Also, in the above embodiment, a plurality of sheets of paper stored in the temporary storage unit 260 are transferred to the abnormal termination paper storage unit 280 when the number of sheets of paper stored in the temporary storage unit 260 does not match with the preset number of sheets of paper. However, a plurality of sheets of paper stored in the temporary storage unit 260 may be discharged to a special paper discharge tray or paper discharge box provided in the paper discharge unit 270 when the number of sheets of paper stored in the temporary storage unit 260 does not match with the preset number of sheets of paper.

Also, in the above embodiment, the number of sheets of paper on which images are formed is determined based on the number information described in the header part of the print data, and compared with the number of sheets of paper stored in the temporary storage unit 260. However, the number of sheets of paper (number of pages) on which images are formed can be determined by analyzing the body part of the print data and compared with the number of sheets of paper stored in the temporary storage unit 260.

Also, in the above embodiment, an abnormal termination process is executed only when the print job is a carbon copy print job. However, an abnormal termination process can be executed in a normal print job of forming images of a plurality of pages not having any object that is common to the pages on sheets of paper.

The units and method of conducting various processes in the image forming system according to the present embodiment can be realized either by a dedicated hardware circuit, or by a programmed computer. The above program can be provided either by a computer readable recording medium such as a flexible disk or CD-ROM, or on-line via a network such as the Internet. In such a case, the program recorded on the computer readable recording medium is normally transferred to and stored on a storage unit such as a hard disk. Also, the above program can be either provided as an application software program or built into the software of the apparatus as one of its function.

What is claimed is:

1. An image forming system comprising a print job transmitting apparatus which transmits a print job and an image forming apparatus which forms images by executing said print job, wherein
said print job transmitting apparatus comprises:
a number setting unit for setting the number of recording media on which images are formed by said image forming apparatus; and
a transmission unit for transmitting a print job that contains number information indicating said number of recording media set up by said number setting unit to said image forming apparatus; while
said image forming apparatus comprises:
an image forming unit for forming images on recording media based on said print job;
a storing unit for storing said recording media on which images are formed by said image forming unit;
a judging unit for judging as to whether or not the number of recording media stored in said storing unit matches with the number indicated by said number information when termination of image forming process by said image forming unit is recognized; and
a control unit for executing an output control for discharging said recording media stored in said storing unit to a first discharge destination when it is judged that said numbers match by said judging unit, and discharging said recording media to a second discharge destination which is different from said first discharge destination when it is judged that said numbers do not match by said judging unit.

2. The image forming system as claimed in claim 1, wherein
said print job transmitting apparatus further comprises:
a control setting unit for setting as to whether or not to execute said output control by said control unit for a print job, wherein
said output control is executed by said control unit in case when it is set to execute said output control for said print job; and
said recording media stored in said storing unit are discharged to said first discharge destination in case when said output control is not executed by said control unit.

3. The image forming system as claimed in claim 1, wherein
said print job contains data for forming images of a plurality of pages containing objects common to those pages on recording media for each page.

4. An image forming apparatus used in an image forming system comprising a print job transmitting apparatus which transmits a print job and an image forming apparatus which forms images by executing said print job, comprising:
a receiving unit for receiving a print job transmitted from said print job transmitting apparatus;
an image forming unit for forming images on recording media based on said print job received by said receiving unit;
a storing unit for storing said recording media on which images are formed by said image forming unit;
a judging unit for judging as to whether or not the number of recording media stored in said storing unit matches with the number of recording media specified based on the information of said print job when termination of image forming process by said image forming unit is recognized; and
a control unit for executing an output control for discharging said recording media stored in said storing unit to a first discharge destination when it is judged that said numbers match by said judging unit, and discharging said recording media to a second discharge destination which is different from said first discharge destination when it is judged that said numbers do not match by said judging unit.

5. The image forming apparatus as claimed in claim 4, wherein
said print job contains number information indicating the number of recording media; and
said judging unit judges as to whether or not the number of recording media stored in said storing unit matches with the number indicated by said number information.

6. The image forming apparatus as claimed in claim 4, wherein
said output control is executed by said control unit in case when it is set to execute said output control for said print job; and
said recording media stored in said storing unit are discharged to said first discharge destination in case when said output control is not executed by said control unit.

7. The image forming apparatus as claimed in claim 4, wherein
said print job contains data for forming images of a plurality of pages containing objects common to those pages on recording media for each page.

8. An image forming apparatus for forming images by executing a print job, comprising:
a job generating unit for generating a print job;
an image forming unit for forming images on recording media based on said print job generated by said job generating unit;
a storing unit for storing said recording media on which images are formed by said image forming unit;
a judging unit for judging as to whether or not the number of recording media stored in said storing unit matches with the number of recording media specified based on the information of said print job when termination of image forming process by said image forming unit is recognized; and
a control unit for executing an output control for discharging said recording media stored in said storing unit to a first discharge destination when it is judged that said numbers match by said judging unit, and discharging said recording media to a second discharge destination which is different from said first discharge destination when it is judged that said numbers do not match by said judging unit.

9. The image forming apparatus as claimed in claim 8, further comprising:
a number setting unit for setting the number of recording media on which images are formed by said image forming apparatus, wherein
said print job contains number information indicating said number of recording media set up by said number setting unit; and
said judging unit judges as to whether or not the number of recording media stored in said storing unit matches with the number indicated by said number information.

10. The image forming apparatus as claimed in claim 8, further comprising:
a control setting unit for setting as to whether or not to execute said output control by said control unit for a print job, wherein
said output control is executed by said control unit in case when it is set to execute said output control for said print job; and
said recording media stored in said storing unit are discharged to said first discharge destination in case when said output control is not executed by said control unit.

11. The image forming apparatus as claimed in claim 8, wherein
said print job contains data for forming images of a plurality of pages containing objects common to those pages on recording media for each page.
